(19) United States
(12) Patent Application Publication
(10) Pub. No.: US 2023/0165278 A1
(43) Pub. Date: Jun. 1, 2023

(54) NUTRITIONAL SUPPLEMENTS COMPRISING DIETARY METAL COMPLEXES IN A MATRIX OF CELLULOSIC MATERIALS

(71) Applicant: North Carolina State University, Raleigh, NC (US)

(72) Inventors: James Martin, Apex (US); Jonathan Holt, Raleigh (US)

(21) Appl. No.: 17/922,766

(22) PCT Filed: May 3, 2021
(86) PCT No.: PCT/US21/30484

§ 371 Date: Nov. 1, 2022

Related U.S. Application Data
(60) Provisional application No. 63/019,062, filed on May 1, 2020.

(51) Int. Cl. A23K 20/24; A23K 20/163; A23K 20/20; A23K 50/30; A23K 50/75; A23L 33/165; A23L 33/24

(52) U.S. Cl. CPC A23K 20/24; A23K 20/163; A23K 20/30; A23K 50/30; A23K 50/75; A23L 33/165; A23L 33/24

(57) ABSTRACT

Disclosed is a composition comprising an effective amount of a dietary metal and a coordinating ligand, wherein the dietary metal is provided as a cationic complex and/or as an anionic complex and wherein the coordinating ligand coordinates the dietary metal cationic complex and/or the dietary metal anionic complex. The composition is used to deliver a dietary metal to a subject in need thereof by administering the composition to the subject, optionally perorally. Examples of the dietary metal include zinc (Zn), copper (Cu), magnesium (Mg), manganese (Mn), iron (Fe), cobalt (Co) and combinations thereof. In a particular example, the coordinating ligand comprises cellulose.

### CROSS-REFERENCE TO RELATED APPLICATIONS

This application claims benefit of U.S. Provisional Patent Application Ser. No. 63/019,062, filed May 1, 2020, which is herein incorporated by reference in its entirety.

### TECHNICAL FIELD

The presently disclosed subject matter relates to nutritional supplements comprising dietary metal complexes and their administration to subjects in need thereof.

### BACKGROUND

Because of the importance of zinc as a micronutrient, there are numerous zinc supplements which are commercially available. The efficacy of zinc nutritional supplements is largely empirically determined. Popular and scientific literature typically refer to supplements merely as zinc materials; however, the bioavailability of zinc from the supplement material is significantly dependent on the counter anion to the Zn²⁺ cation. Solubilities range from ZnCl₂, for which 4 kg dissolve in 1 L of water, to Zn₃(PO₄)₂ which is insoluble.

Zinc oxide, ZnO, is relatively insoluble except in acid, but, for example, has been demonstrated to exhibit therapeutic effects, such as preventing post-weaning diarrhea and mortality in pigs. Large dosages of ZnO for therapeutic use (2,500 ppm Zn) present significant environmental concerns with respect to zinc accumulation in the soil and run-off in water supplies. As a result of this environmental concern ZnO has been banned and/or severely limited in multiple EU countries.

Thus, improvements in nutritional supplements comprising dietary metals, including zinc, represent a long-felt and ongoing need in the art.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

In accordance with some embodiments of the presently disclosed subject matter provided is a method of delivering a dietary metal to a subject in need thereof. In some embodiments, the method comprises: providing a composition comprising an effective amount of a dietary metal and a coordinating ligand, wherein the coordinating ligand encapsulates the dietary metal and/or the dietary metal is provided as a cationic complex and/or as an anionic complex and wherein the coordinating ligand coordinates the dietary metal cationic complex and/or the dietary metal anionic complex; and administering the composition to the subject, optionally perorally. In some embodiments, the dietary metal is selected from the group comprising zinc (Zn), copper (Cu), magnesium (Mg), manganese (Mn), iron (Fe), cobalt (Co), and combinations thereof.

In some embodiments, the coordinating ligand comprises a water insoluble polysaccharide (PS). In some embodiments, the coordinating ligand comprises cellulose.

In some embodiments, the dietary metal anionic complex comprises a dietary metal halide complex. In some embodiments, the dietary metal cationic complex comprises a dietary metal hydrate complex. In some embodiments, the dietary metal anionic complex comprises a [ZnCl₄]²⁻ complex or a [ZnCl4-y(OH)_{y}]²⁻ complex. In some embodiments, the dietary metal cationic complex comprises a [Zn(OH₂)₆]²⁺ complex or a [Zn(OH₂)₆₋ₙ(PS)ₙ]²⁺ complex. In some embodiments, Zn is present in an amount ranging up to about 50 wt. %, optionally up to about 30 wt. %. In some embodiments, PS is cellulose.

In some embodiments, the composition comprises [M(OH₂)ₓ(PS)][ZnCl₄], wherein M is a dietary metal or a combination of dietary metals, wherein PS is a polysaccharide, and wherein x ranges from 0 to 18, optionally 0 to 6. In some embodiments, M is selected from the group consisting of Zn, Cu, Mg, Mn, Fe, Co, and combinations thereof. In some embodiments, M is selected from the group consisting of Zn, Cu, and combinations thereof. In some embodiments, M is present in an amount ranging up to about half of the total metal content, optionally up to about 15 wt. %. In some embodiments, PS is cellulose. In some embodiments, the composition comprises a morphology selected from the group consisting of a power, a gel, and a film.

In some embodiments, the dietary metal anionic complex comprises about half the dietary metal in the composition and wherein the dietary metal cationic complex comprises about half the dietary metal in the composition. In some embodiments, the composition is prepared by dissolving the coordinating ligand in an ionic liquid composition comprising the dietary metal anionic complex and/or the dietary metal cationic complex, optionally further comprising precipitating the composition.

In some embodiments, the composition further comprises a biologically acceptable excipient and/or carrier, in addition to the coordinating ligand. In some embodiments, the subject is a non-human animal subject, optionally a monogastric subject, further optionally a swine subject or a poultry subject, or is a human subject. In some embodiments, administering the composition delivers the dietary metal to a lower gut of the subject, optionally wherein the delivery to the lower gut is higher as compared to a dietary metal without a coordinating ligand. In some embodiments, the digestibility of the composition in the upper gut of the subject is substantially reduced as compared to a composition without a coordinating ligand.

Provided in accordance with some embodiments of the presently disclosed subject matter is a composition, which in some embodiments is provided as a nutritional supplement composition for peroral administration. In some embodiments, the composition comprises an effective amount of a dietary metal and a coordinating ligand, wherein the coordinating ligand encapsulates the dietary metal and/or wherein the dietary metal is provided as a cationic complex and/or as an anionic complex and wherein the coordinating ligand coordinates the dietary metal cationic complex and/or the dietary metal anionic complex. In some embodiments, the dietary metal is selected from the group comprising zinc (Zn), copper (Cu), magnesium (Mg), manganese (Mn), iron (Fe), cobalt (Co) and combinations thereof.

In some embodiments, the coordinating ligand comprises a water insoluble polysaccharide (PS). In some embodiments, the coordinating ligand comprises cellulose.

In some embodiments, the dietary metal anionic complex comprises a dietary metal halide complex. In some embodiments, the dietary metal cationic complex comprises a dietary metal hydrate complex. In some embodiments, the dietary metal anionic complex comprises a [ZnCl₄]²⁻ complex or a [ZnCl_{4-y}(OH)_{y}]²⁻ complex. In some embodiments, the dietary metal cationic complex comprises a [Zn(OH₂)₆]²⁺ complex or a [Zn(OH₂)₆₋ₙ(PS)ⁿ]²⁻ complex. In some embodiments, Zn is present in an amount ranging up to about 50 wt. %, optionally up to about 30 wt. %. In some embodiments, PS is cellulose.

In some embodiments, the composition comprises [M(OH₂)ₓ(PS)][ZnCl₄], wherein M is a dietary metal or a combination of dietary metals, wherein PS is a polysaccharide, and wherein x ranges from 0 to 18, optionally 0 to 6. In some embodiments, M is selected from the group consisting of Zn, Cu, Mg, Mn, Fe, Co, and combinations thereof. In some embodiments, M is selected from the group consisting of Zn, Cu, and combinations thereof. In some embodiments, M is present in an amount ranging up to about half of the total metal content, optionally up to about 15 wt. %. In some embodiments, PS is cellulose. In some embodiments, the composition comprises a morphology selected from the group consisting of a power, a gel, and a film.

In accordance with some embodiments of the presently disclosed subject matter, provided is an ionic liquid, which has the formula [Zn(OH₂)₆(OH₂)ₓ][ZnCl₄], wherein x ranges from 0 to 180, and provided is an ionic liquid which has the formula [Zn(OH₂)₆(OH₂)ₓ][ZnCl_{4-y}(OH)_{y}], wherein x ranges from 4 to 36.

In some embodiments, the dietary metal anionic complex comprises about half the dietary metal in the composition and the dietary metal cationic complex comprises about half the dietary metal in the composition. In some embodiments, the composition is prepared by dissolving the coordinating ligand in an ionic liquid composition comprising the dietary metal anionic complex and the dietary metal cationic complex, optionally further comprising precipitating the composition.

In some embodiments, the composition further comprises a biologically acceptable excipient and/or carrier, in addition to the coordinating ligand. In some embodiments, the nutritional supplement composition is adapted for administration to a non-human animal subject, optionally a monogastric subject, further optionally a swine subject or a poultry subject, or to a human subject. In some embodiments, the composition delivers the dietary metal to the lower gut of the subject, optionally wherein the delivery to the lower gut is higher as compared to a dietary metal without a coordinating ligand. In some embodiments, the digestibility of the composition in the upper gut of the subject is substantially reduced as compared to a composition without a coordinating ligand.

Accordingly, it is an object of the presently disclosed subject matter to provide compositions, including nutritional supplement compositions, and related methods. This and other objects are achieved in whole or in part by the presently disclosed subject matter. Further, an object of the presently disclosed subject matter having been stated above, other objects and advantages of the presently disclosed subject matter will become apparent to those skilled in the art after a study of the following description.

### DETAILED DESCRIPTION

The presently disclosed subject matter now will be described more fully hereinafter. The presently disclosed subject matter may, however, be embodied in many different forms and should not be construed as limited to the embodiments set forth herein; rather, these embodiments are provided so that this disclosure will be thorough and complete, and will fully convey the scope of the presently disclosed subject matter to those skilled in the art.

### I. DEFINITIONS

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

Following long-standing patent law tradition, the terms “a”, “an”, and “the” are meant to refer to one or more as used herein, including the claims. For example, the phrase “a solvent” can refer to one or more solvents. Also as used herein, the term “another” can refer to at least a second or more.

The term “about”, as used herein when referring to a measurable value such as an amount of weight, time, etc., is meant to encompass variations of in some embodiments ±20%, in some embodiments ±10%, in some embodiments, ±5%, in some embodiments ±1%, and in some embodiments ±0.1% from the specified amount, as such variations are appropriate to perform the disclosed methods.

The use of the term “or” in the claims is used to mean “and/or” unless explicitly indicated to refer to alternatives only or the alternatives are mutually exclusive.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

As used herein, the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As used herein, “significance” or “significant” relates to a statistical analysis of the probability that there is a non-random association between two or more occurrences. To determine whether or not a relationship is “significant” or has “significance”, statistical manipulations of the data can be performed to calculate a probability, expressed as a “p-value”. Those p-values that fall below a user-defined cutoff point are regarded as significant. In some embodiments, a p-value less than or equal to 0.10, in some embodiments less than or equal to 0.05, in some embodiments less than or equal to 0.01, in some embodiments less than or equal to 0.005, and in some embodiments less than or equal to 0.001, are regarded as significant.

The term “polymer” as used herein refers to a substance comprising a macromolecule. Polymers include both natural polymers (e.g., proteins, cellulose, etc.) and synthetic polymers. In some embodiments, the term “polymer” can include both oligomeric molecules and molecules with larger numbers (e.g., >10, >20, >50, >100) of repetitive units. In some embodiments, “polymer” refers to macromolecules with at least 10 repetitive units.

As used herein, a “monomer” refers to a molecule that can undergo polymerization, thereby contributing constitutional units, i.e., an atom or group of atoms, to the essential structure of a polymer.

An “oligomer” as used herein can refer to a molecule of intermediate relative molecular mass, the structure of which comprises a small plurality (e.g., 2, 3, 4, 5, 6, 7, 8, 9, or 10) of repetitive units derived from molecules of lower relative molecular mass.

A “copolymer” refers to a polymer derived from more than one species of monomer.

The term “biodegradable” as used herein refers to polymeric materials that can break down (e.g., via the action of microbes) to form monomeric materials.

An “effective amount” of an agent is that amount of agent which is sufficient to provide a beneficial effect to the subject to which the agent is administered. By way of example and not limitation, standard diets for swine include zinc between 100-150 ppm to meet nutrient requirements in all stages of growth. When fed at high levels, zinc can promote a healthy digestive tract and increase growth of the animal. Levels from 2000-3000 mg zinc/kg feed are typically used in pigs from 3-8 weeks of age. Similar results are expected at lower levels of zinc-cellulose compositions in accordance with the presently disclosed subject matter. Copper is also typically used at 125-300 mg cu/kg feed for increased growth although the pigs' requirement for copper is only 10-15 ppm. Zinc is commonly fed in poultry rations between 60-125 ppm to meet the birds' requirement.

### II. GENERAL CONSIDERATIONS

Because cellulose is the most abundant natural polymer, there has been substantial interest in developing methods to dissolve and functionalize cellulose. Such methods were recently reviewed (Sen Martin Sustainable Chem. Eng. 2013, 1, 858), which include the solubility of cellulose in select zinc chloride hydrates. Having discovered the molecular structure of the active zinc chloride hydrate, a further study of how/why this zinc chloride hydrate is capable of dissolving cellulose was performed (Sen Martin J. Phys. Chem. B, 2016, 120, 1134). For these applications, the encapsulation of zinc in the cellulose is seen as problematic, and efforts are engaged to remove the zinc, leaving pure cellulose. In that later work, it was demonstrated by thermogravimetric analysis that the as precipitated material contains approximately 20% by weight zinc, though like other prior efforts, methods were demonstrated to remove the zinc from the cellulose.

Because of the importance of zinc as a micronutrient, there are numerous zinc supplements which are commercially available. The efficacy of zinc nutritional supplements is largely empirically determined. Popular and scientific literature typically refer to supplements merely as zinc materials; however, the bioavailability of zinc from the supplement material is significantly dependent on the counter anion to the Zn²⁺ cation. Solubilities range from ZnCl₂, for which 4 kg dissolve in 1 L of water, to Zn₃(PO₄)₂ which is insoluble.

Maintaining healthy zinc levels is accomplished in the gastrointestinal system. The most common zinc nutritional supplements, zinc gluconate, Zn(O₂C(CHOH)₄CH₂OH)₂, zinc sulfate, ZnSO₄, and zinc acetate, Zn(O₂CCH₃)₂ are highly soluble, and thus absorbed earlier in the gastrointestinal system, particularly in the small intestine, liver and pancreas. Zinc oxide, ZnO, is relatively insoluble except in acid, but, for example, has been demonstrated to exhibit important therapeutic effects preventing post-weaning diarrhea and mortality in pigs. The less soluble form of zinc persists further into the gastrointestinal system and is thought to provide antimicrobial effects in the large intestine. While ZnO in swine feed has reduced the use of anti-biotics, the large dosages of ZnO for therapeutic use (2,500 ppm Zn) present significant environmental concerns with respect to zinc accumulation in the soil and run-off in water supplies. As a result of this environmental concern ZnO has been banned and/or severely limited in multiple EU countries.

In accordance with the presently disclosed subject matter, provided here in some embodiments are compositions that effectively encapsulate zinc within the biopolymer cellulose by direct binding between the Zn and hydroxyl functional groups on cellulose and/or by the formation of a zinc-cellulose cationic complex ion that is ionically bound to a zinc chloride anionic complex. For the zinc-cellulose complex cation, cellulose becomes a ligand coordinated to the zinc. Particularly, in a stoichiometric embodiment, a composition of matter of the presently disclosed subject matter has the chemical formula [Zn(OH₂)ₓcellulose][ZnCl₄] for which x may be between about 0 and 18, optionally between 0 and 6. Measurements demonstrate that the composition can be prepared with varying amounts of the zinc chloride incorporated into the cellulose such that compositions may contain 0-30 wt. % zinc, with the balance of mass being the chloride, cellulose and water. When bound to the biopolymer, the zinc is not soluble in aqueous solution. It can be removed from the polymer under alkali or acidic conditions. Encapsulation in cellulose delays absorption such that the compositions are a more effective supplement to deliver zinc to the large intestine than either the small anion sources (e.g. zinc gluconate, zinc sulfate or zinc acetate) or the insoluble forms, such as zinc oxide. The unique characteristics of compositions of the presently disclosed subject matter increase the bioavailability of zinc to the large intestine, providing the desired therapeutic effect with a lower total concentration of zinc, thus mitigating the environmental impact of the high zinc oxide dosages.

Other zinc oxide encapsulation strategies have been reported. Encapsulants include zeolites, smectic clays and lipids, for example (see J. Animal Sci. Tech, 2014, 56:29 and references therein). In some embodiments, the presently disclosed subject matter both utilizes a more cost effective encapsulant, cellulose, than other reported methods, and provides atomically dispersed zinc, as opposed to mineral or even nano-particulate ZnO.

In addition to their contribution to antimicrobial effects in the large intestine, and reduced environmental impacts as compared to ZnO, the compositions of the presently disclosed subject matter can contribute to energy utilization. Zinc chloride, particularly in the presence of mineral acids such as those found in the stomach, is known to facilitate the decomposition of cellulose into smaller oligosaccharides, even to glucose. While glucose units are the backbone of the biopolymer cellulose, cellulose provides no nutritional value. However, when broken down to its simple sugar components, glucose is a high energy material. If not fully broken down into simple sugars, but instead to oligosaccharides, the oligosaccharide derivatives of compositions of the presently disclosed subject matter provide useful prebiotic nutritional effects.

In some embodiments, the presently disclosed subject matter addresses the need for other dietary metals, such as but not limited to copper. Copper is needed as a micronutrient, and also exhibits antimicrobial activity. In accordance with the presently disclosed subject matter, in some embodiments provided are compositions that exchange the zinc metal of the zinc-cellulose complex cation for other micronutrient metals such as copper. Herein the biopolymer cellulose is directly bound to the secondary metal, such as copper, by direct binding between the metal and hydroxyl functional groups on cellulose, with zinc persisting in the metal-biopolymer complex as the zinc chloride counter anion. This, for example in the embodiment with copper, yields a novel composition of matter with copper incorporation up to a stoichiometric embodiment [Cu(OH₂)ₓcellulose][ZnCl₄] for which x may be between about 0 and 18, optionally between 0 and 6. In some embodiments, this composition of matter can contain up to 30 wt. % metal with at least half of the metal content being zinc and the other half of metal content may be an alternative metal, such as but not limited to copper.

In some embodiments, other water insoluble metal hydroxides can be co-dissolved with cellulose (or other polysaccharide) into a zinc chloride hydrate medium. The additional metal hydroxide species can be co-precipitated with the zinc chloride cellulose complex by which zinc is chemically bound to the cellulose and the metal hydroxide is physically encapsulated into the cross-linked cellulose biopolymer. This method of co-precipitation of the zinc chloride cellulose complex and the metal hydroxide, in an embodiment using basic zinc chloride as the metal hydroxide species, can be used to increase the metal content to 50 wt. % zinc.

### III. EXEMPLARY EMBODIMENTS

In some embodiments, the presently disclosed subject matter a novel dietary metal nutritional supplement is prepared in which a dietary metal, such as zinc, is molecularly dispersed within and bound to a polysaccharide, such as a water insoluble polysaccharide, such as cellulose.

In some embodiments, the presently disclosed subject matter provides a method of delivering a dietary metal to a subject in need thereof. In some embodiments, the method comprises providing a composition comprising an effective amount of a dietary metal and a coordinating ligand; and administering the complex to the subject, optionally perorally. In some embodiments, the dietary metal is provided as a cationic complex and/or as an anionic complex. In some embodiments, the coordinating ligand encapsulates the dietary metal, coordinates the dietary metal cationic complex and/or coordinates the dietary metal anionic complex, and/or any combination thereof.

In some embodiments, the presently disclosed subject matter provides a composition comprising a metal, such as a dietary metal, such as a nutritional supplement composition. In some embodiments, the nutritional supplement composition is adapted for peroral administration. In some embodiments, the nutritional supplement composition comprises an effective amount of a dietary metal and a coordinating ligand. In some embodiments, the dietary metal is provided as a cationic complex and/or as an anionic complex. In some embodiments, the coordinating ligand encapsulates the dietary metal, coordinates the dietary metal cationic complex and/or coordinates the dietary metal anionic complex, and/or any combination thereof.

As used herein, the term “dietary metal” encompasses metals that form part of normal dietary requirements for subjects, such as mammals, such as animals and humans. The dietary metal can be any suitable dietary metal, or any suitable combination of dietary metal, as would be apparent to one of ordinary skill in the art upon a review of the instant disclosure. In some embodiments, the dietary metal is selected from the group comprising zinc (Zn), copper (Cu), magnesium (Mg), manganese (Mn), iron (Fe), cobalt (Co), and combinations thereof. In some embodiments, the dietary metal is Zn, which has a representative non-limiting beneficial effect in preventing diarrhea in animals.

In some embodiments, the coordinating ligand comprises a polysaccharide (PS). In some embodiments, the polysaccharide is a water insoluble ligand, such as but not limited to cellulose, starch, glycogen, chitin, hemicellulose, lignin, amylopectin, and amylose. Other examples of polysaccharides include maltose, cellobiose, galactose, ribose, dextrin, and inulin. Indeed, effectively any polysaccharide, optionally water insoluble polysaccharide, can be included in place of or in addition to cellulose as the coordinating ligand.

In a particular, non-limiting example, the presently disclosed compositions comprise cellulose as a coordinating ligand and comprise zinc chloride as the metal complex for which the zinc may be imbodied as a hydrated cationic complex and/or as an anionic chloride coordinated complex. However, the presently disclosed subject matter provides a broad class of related polysaccharide/zinc chloride products derived from this example. The bioavailability of the zinc dietary metal can be modulated by the size of the component oligosaccharide including but not limited to: starch, glycogen, chitin, hemicellulose, lignin amylose, maltose, cellobiose, galactose, ribose, dextrin, amylopectin, and inulin.

In some embodiments, the dietary metal complex, optionally a dietary metal anionic complex, comprises a dietary metal halide complex. In some embodiments, the dietary metal cationic complex comprises a dietary metal hydrate complex. In some embodiments, the dietary metal anionic complex comprises a [ZnCl₄]²⁻ complex or a [ZnCl_{4-y}(OH)_{y}]²⁻ complex. In some embodiments, the dietary metal cationic complex comprises a [Zn(OH₂)₆]²⁺ complex or a [Zn(OH₂)₆₋ₙ(PS)ₙ]²⁺ complex. In some embodiments, the dietary metal complex, optionally a dietary metal anionic complex, comprises about half the dietary metal in the composition and the dietary metal cationic complex comprises about half the dietary metal in the composition.

In some embodiments, the composition is prepared by dissolving the coordinating ligand in an ionic liquid composition comprising the dietary metal anionic complex and the dietary metal cationic complex. In some embodiments, the method further comprises precipitating the composition. By way of exemplification and not limitation, the molten hydrate of zinc chloride comprising precisely 3 equivalents of water per equivalent of ZnCl₂, and also compositions between about 2.5 and 3.5 equivalents of water per equivalent of ZnCl₂, exhibit the structure and properties of an ionic liquid whereby the hydrated water molecules act as strong hydrogen bond donors while the overall material presents as a non-polar solvent because neither of the molecular ions [Zn(OH₂)₆]²⁺ and [ZnCl₄]²⁻ are polar. The particular composition of this ionic liquid, [Zn(OH₂)₆][ZnCl₄], allows this zinc chloride hydrate to dissolve cellulose. Cellulose, the most naturally abundant biopolymer, is a polymer comprising glycosyl polymeric units (C₆H₁₀O₅)ₙ. As a polymer it is non-polar; however, the large number of hydroxyl functional groups result in extensive crosslinking by intramolecular hydrogen bonding, preventing solubility in most solvents, including water. However, in this zinc chloride hydrate composition, certain of the hydroxyl groups of cellulose can be bound directly to the zinc via a single bond, while other hydroxyl groups form part of higher hydration shells of the zinc chloride hydrate system. Other polysaccharides, such as the examples disclosed herein, behave similarly in this matter to cellulose. As such this zinc chloride hydrate can readily dissolve 0.5 to 2 wt. % by weight of cellulose or other polysaccharide. In some embodiments, 5-10 wt. % of cellulose or other polysaccharide, and in some embodiments up to 30 wt. % cellulose or other polysaccharide, can be dissolved into a gel of the zinc chloride hydrate.

By way of continued elaboration and not limitation, the ionic liquid [Zn(OH₂)₆][ZnCl₄], comprising a 25 mol % ZnCl₂ 75 mol % H₂O solution, is prepared. This material has a density of 2 g/ml. Cellulose is dissolved into this solution. In some embodiments, 0.5 wt. % of cellulose is dissolved into this solution. In a particular, non-limiting representative embodiment, to dissolve the cellulose, the zinc chloride hydrate solution is first cooled, such as to below 10° C., in an ice bath into which the cellulose is added to form a slurry. In this embodiment, upon warming to room temperature or above, the cellulose dissolves. In some embodiments, dissolution may be facilitated by heating the solution. It can readily be heated up to 80° C. without breaking down the cellulose. Preparations with higher amounts of cellulose result in solutions that are quite viscous. In general preparations using higher percentages of cellulose yield products with a lower final percentage of zinc being bound to the cellulose. In some embodiments, the ionic liquid comprises a range of about 20 to about 30 mol % ZnCl₂.

Once the cellulose is dissolved, additional water is added to the system, resulting in the precipitation of the zinc-cellulose complex. When additional water (for example, greater than 9 equivalents of water with respect to Zn) is added to the solution of zinc chloride and cellulose, the cellulose will precipitate, carrying along the molecularly bound zinc chloride into the solid cellulose-zinc chloride precipitate. In some embodiments, to fully precipitate the zinc cellulose complex from solution, 75 to 100 equivalents of water are added to the solution. The precipitate is then filtered or centrifuged, washed with pure water and dried. The solid white powder product contains approximately 10-30 wt. % Zn. The precipitate is filtered or separated by centrifugation, washed with pure water, and dried. The product can then be directly used as a nutritional supplement. Indeed, this product was used in the composition of the presently disclosed subject matter tested in the swine study described herein below.

A particular representative, non-limiting embodiment of the preparation conditions can be used to achieve precipitates with morphologies ranging from a very fine power to a gel or to film. Embodiments prepared with 0-2% by weight cellulose dissolve to form a viscous, albeit reasonably fluid solution. When diluted into the 75-100 equivalents of water, the zinc-cellulose complex forms an extremely fine precipitate that readily can be separated from the supernatant by centrifugation. This material is then dried and ground into a fine powder. Embodiments prepared with 5-10 wt. % cellulose from a clear and highly viscous gel. The 5% systems result in a texture similar to crystallized honey and the 10% system forms a texture that is in between the hardness of taffy and hard candy. When the 5-10% cellulose systems are diluted into an excess of water, the excess zinc chloride is washed away, and the precipitated product remains in whatever shape or form it was in when diluted into the water. If poured as a stream into the diluting water, then pasta-like strings of material result. If beads are dropped into water, then beads of material result. These chunks can be broken up by vigorous stirring, and then can be separated from the supernatant by filtration. Notably, the density gradient between the precipitated gels and the supernatant is not sufficient to allow separation by centrifugation. Alternatively, the gel material can be spread out onto a surface such as a glass plate or the walls of a beaker forming a thin film of material. When diluted with excess water these films can be floated off the surface onto which they were spread. These zinc-cellulose products all shrink when dried. The “chunkier” material becomes hard and can be ground to a fine powder. The dried thin films have a texture and strength somewhat like wax paper or saran wrap.

In some embodiments, one or more steps are provided to reuse the zinc chloride solvent for subsequent syntheses. For example, water from the supernatant can be evaporated, returning the solvent back to the active concentration of the three-equivalent hydrate. In some embodiments, HCl is added to the mixture to convert any zinc hydroxide that may have formed back to the zinc chloride.

In some embodiments, the [Zn(OH₂)₆][ZnCl₄] ionic liquid is directly combined with cellulose in the ratio of two equivalents of zinc to one equivalent of cellulose; a final composition that is 30 weight % cellulose. Upon addition of the cellulose to the ionic liquid a slurry is formed. With continued vigorous stirring the slurry stiffens and hardens such that it is subsequently ground to mechanically mix the reactants. The resulting product is a soft white powder which is not deliquescent. Drying the material at 45° C. results in loss of the waters of hydration and a harder material. In this embodiment, a fraction of the zinc chloride is directly bound to the cellulose providing a water insoluble form of zinc. The balance of the zinc chloride is water soluble. At least 1 to 10% of the zinc can be embodied as the insoluble form of zinc.

In further embodiments the original ZnCl₂ can be mixed with a basic form of zinc chloride; a compound with the chemical formula Zn₅Cl₂(OH)₈.H₂O. In one embodiment 1-2 wt. % basic zinc chloride is mixed with pure zinc chloride. The basic zinc chloride, while highly insoluble in water, dissolves in the zinc chloride ionic liquid when two additional equivalents of water are added, specifically containing a ratio of about five equivalents of water per equivalent of zinc. This mixture forms a novel ionic liquid in which the hydroxyl anions act as ligands that directly bind to the zinc and having a formula [Zn(OH₂)₆(OH₂)ₓ][ZnCl_{4-y}(OH)_{y}], when x ranges for 4 to 36. The hydroxyl ligands bound to zinc can effectively form hydrogen bonds with the cellulose, resulting in comparable solubility as is observed for the pure zinc chloride hydrate. 0.5 wt. % to 10 wt. % cellulose is dissolved in the zinc chloride-basic zinc chloride ionic liquid. The resultant solutions are moderately viscous fluids for solutions with up to 2 wt. % cellulose but form the viscous gels with 5 wt. % to 10 wt. % of cellulose. After dissolution for 2 to 12 h, the cellulose zinc ionic liquid solutions are diluted with 75 to 100 equivalents of pure water, causing the zinc-cellulose material to precipitate, analogous to the preparations in the pure zinc chloride hydrate ionic liquid solutions. The precipitates are separated from the supernatant by filtration or centrifugation, thoroughly washed in pure water, then dried. The resultant solid product in the form of a powder, gel or film is a mixture of cellulose chemically bound to zinc chloride, i.e., the complex formed from the reaction of cellulose with the pure zinc chloride hydrate ionic liquid, and cellulose encapsulated basic zinc chloride. The encapsulation by coprecipitation of the basic zinc chloride by cellulose has been used to achieve compositions with up to 50 wt. % zinc. Indeed, this product was used in the composition of the presently disclosed subject matter tested in the swine study described herein below, as a mixture with the product mentioned above.

In accordance with some embodiments of the presently disclosed subject matter, provided is an ionic liquid, which has the formula [Zn(OH₂)₆(OH₂)ₓ][ZnCl₄], wherein x ranges from 0 to 180, and provided is an ionic liquid which has the formula [Zn(OH₂)₆(OH₂)ₓ][ZnCl_{4-y}(OH)_{y}], wherein x ranges from 4 to 36.

The precipitated products can be used as precipitated as a food additive. Further optional steps include compressing into pellets or other formulations to address specific needs/preferences for specific feed delivery. The product can be dried to be incorporated into livestock feeds as a supplement. The final dried product can also be ground into a size that allows it to be mixed consistently into feed rations. In some embodiments, the presently disclosed compositions are provided in powdered form. The powder can be mixed with other solid feeds. However, it is also possible that the liquid or gel form with the coordinating ligand, e.g., water insoluble polysaccharide, e.g., cellulose, dissolved in an ionic liquid comprising the dietary metal cationic complex and/or the dietary metal anionic complex could also be a useful delivery form. Particularly with respect to an embodiment comprising zinc chloride and cellulose, in solution form there is a much higher concentration of zinc chloride that is not bound to the cellulose. Such zinc chloride would be available for absorption in the upper digestive tract, with the zinc bound to the cellulose being delivered to the lower digestive tract.

The nature of bonding between the zinc chloride hydrate and cellulose can be equivalently embodied with, but not limited to: starch, glycogen, chitin, hemicellulose, lignin amylose, maltose, cellobiose, galactose, ribose, dextrin, amylopectin, inulin, and effectively any polysaccharide. Each of these backbone molecules/polymers is expected to exhibit distinct solubility, thus facilitating targeted bioavailability of each composition embodiment to different regions of the digestive tract. Related ionic liquid hydrates are prepared using other micronutrient metals and mixtures of metals including but not limited to Cu, Mg, Mn, Co and Fe. The dietary metal utilized in the solubilizing or diluting solutions results in polysaccharide (e.g., cellulose)-dietary metal products with distinct minerals which will have distinct nutritional/antimicrobial function. It is further possible to prepare related ionic liquid hydrates, the materials used to incorporate the dietary metals with the coordinating ligand, using other dietary metals and mixtures of dietary metals including but not limited to Cu, Mg, Mn, Co and Fe. The dietary metal utilized in the solubilizing or diluting solutions results in nutritional supplement compositions with distinct dietary metals and combinations thereof, which have distinct nutritional/antimicrobial function. Representative ionic liquid solutions include (Cu/Zn)Cl₂ and (Mn/Zn)Cl₂ hydrate ionic liquid solutions that are analogous to the ZnCl₂ solutions. Such embodiments include mixtures of hydrated metal cations including [M(OH₂)₆]²⁺ and/or [M(PS)ₙ(OH₂)₆₋ₙ]²⁺, where M is selected from metals such as Cu, or Mn in combination with the anionic zinc complex [ZnCl₄]²⁻ and/or the anionic complex [ZnCl_{4-y}(OH)_{y}]²⁻ and (PS) is a polysaccharide as defined herein, such as cellulose.

In some embodiments, the composition comprises a molecule having the formula [M(OH₂)ₓ(PS)][ZnCl₄], wherein M is a dietary metal or a combination of dietary metals, wherein PS is a polysaccharide, and wherein x ranges from 0 to 18, optionally 0 to 6. In some embodiments, M is selected from the group comprising Zn, Cu, Mg, Mn, Fe, Co, and combinations thereof. In some embodiments, M is selected from the group comprising Zn, Cu, and combinations thereof. In some embodiments, M is present comprising up to half of the total metal content, in an amount ranging up to about 15 wt. % of the total metal content being M and about 15 wt. % of the metal being Zn. In some embodiments, PS is cellulose.

Because the ionic liquid [Zn(OH₂)₆][ZnCl₄] works well for dissolving cellulose, in some embodiments other dietary metals are incorporated into the final cellulose-metal complex by first dissolving the cellulose into the zinc chloride hydrate ionic liquid as described above. After the cellulose is fully dissolved in the zinc chloride hydrate, a saturated solution of another metal chloride salt is added to the solution prior to the addition of excess water for precipitation. In some embodiments, a saturated copper chloride hydrate solution, CuCl₂.10H₂O, is added to the cellulose-zinc chloride ionic liquid solution such that the cellulose to Cu ratio is 1:10. With stirring at room temperature a precipitate slowly begins to form. For preparations with 0-2 wt. % cellulose the precipitate is a fine power. For preparations with 5-10 wt. % cellulose the precipitate is a gel, similar to that observed for the pure zinc chloride system. The copper-zinc gel can also be fabricated as a film as described for the pure zinc system. The initially precipitated material is further diluted with 75-100 equivalents of water, then separated from the supernatant by filtration or centrifugation, thoroughly washed with fresh water, and then dried. The resulting powder or film exhibits a bluish green color. The intensity of the color being proportional to the extent of copper incorporation which in some embodiments may be up to about 15 wt. % copper and about 15 wt. % zinc.

In an alternative embodiment, the as precipitated pure zinc-cellulose complex is centrifuged or filtered to separate it from the supernatant. The wet precipitate is then added to a saturated aqueous solution of copper chloride, CuCl₂.10H₂O and stirred for 2-12 h to allow for ion exchange. The ion-exchanged metal-cellulose complex does not dissolve in the saturated copper chloride solution. However, the original white zinc-cellulose complex turns to the bluish-green color of the Cu/Zn cellulose complex. The ion-exchanged material is then diluted into 75-100 equivalents of pure water. The precipitate is separated from its supernatant by filtration or centrifugation, thoroughly washed with pure water and dried. In some embodiments, the ion-exchanged materials may contain up to about 15 wt. % copper and about 15 wt. % zinc.

Other metal hydroxides are also soluble in the zinc chloride hydrate ionic liquid. Any metal hydroxide so dissolved co-precipitates with the cellulose, forming a mixed metal/cellulose composite.

In some embodiments, the composition further comprises a biologically acceptable excipient and/or carrier, in addition to the coordinating ligand. The term “acceptable excipient and/or carrier” is intended to mean substances, which are substantially harmless to the individual to which the composition will be administered. Such excipients normally fulfil the requirements given by national drug agencies and/or feed stuff legislation, official pharmacopeias such as the United States of America Pharmacopeia and the European Pharmacopeia set standards for well-known pharmaceutically acceptable excipients. Other examples are disclosed in PCT Publication No. WO 2004/080210, herein incorporated by reference in its entirety.

The term “peroral administration” is intended to mean administration to an individual of a composition through the mouth, preferably where the release and absorption of the therapeutically active principle is not intended to occur in the oral cavity, but rather after passing the oral cavity, such as in the gastro-intestinal tract.

As used herein the term “subject” refers to an animal, including a human, in need of supplementary doses of one or more dietary metals. The subject can be of any age, ranging from newborn to adult. The animal can be further characterized as having or being prone to poor development of the lower gut. Signs of poor development of the lower gut include presence of adverse changes in intestinal morphology. The animal may also be characterized by being in growth phase, such as a young animal before being fully matured as an adult animal. Non-limiting examples include of animals include pigs, in particularly weaned pigs, pigs in growth phase; chickens such as chickens in growth phase; and calves such as calves in growth phase. In some embodiments, the subject is a non-human animal subject, optionally a monogastric subject, further optionally a swine subject or a poultry subject, or is a human subject.

In some embodiments, administering the composition delivers the dietary metal to a digestive tract of the subject, optionally wherein the delivery to the lower gut is higher as compared to a dietary metal without a coordinating ligand. In some embodiments, delivery into the lower digestive tract comprises entry into the ceca (for poultry) or cecum (for swine). In some embodiments, the digestibility of the composition in the upper gut of the subject is substantially reduced as compared to a composition without a coordinating ligand.

As used therein the term “coordinating ligand” refers to a ligand that forms a single bond with a dietary metal. By way of example and not limitation, there is a single OH from a polysaccharide, such as cellulose, that is bound to the dietary metal. This is in contrast to a chelate or chelating ligand, which is a ligand bound to a metal in two or more places. Further, a “coordinating ligand” in some embodiments of the presently disclosed subject matter is provided through the solubilizing of otherwise insoluble polysaccharides, such as cellulose, by complexation with a metal halide (e.g., metalchloride) hydrate ionic liquid. This is in contrast to prior approaches, which relate to systems prepared by mixing a soluble metal salt with a soluble amino acid or polysaccharide. Further, prior systems appear to consider complexes where the amino acid or other ligand is the exclusive or primary ligand bound to the metal and result in a neutral molecular or macromolecular coordination complex. By contrast, in some embodiments, the presently disclosed subject matter provides a composition that is a complex salt whereby the coordinating ligand (e.g., a polysaccharide, such as cellulose) displaces some of the water of a hydrated cation forming a molecular or macromolecular complex ion, that is charge balanced with a metalhalide ion, e.g. [MCl₄]²⁻ and/or [MCl_{4-y}(OH)_{y}]²⁻. Thus, in some embodiments, the presently disclosed subject matter provides compositions that are complex salts with a combination of complex inorganic and organic ions rather than a neutral, molecular or macromolecular chelated system. Thus, in some embodiments, the compositions of the presently disclosed subject matter are described with the formula [M(PS)ₙ(OH₂)₆₋ₙ][MHalide₄ e.g. MCl₄], where PS stands for a polysaccharide, such as cellulose.

Continuing, most applications of zinc in biological function are presumed to be the Zn²⁺ cation that is ligated by various species. The presumption is that when released from the ligand Zn²⁺ is provided to the organism. In the presence of chloride, as well as other halides such as bromide and iodide, the halide remains bound to the zinc, forming an anionic species. For chloride the anion formed is [ZnCl₄]²⁻, and in aqueous solution, half the zinc forms a hydrated cation, and half forms this anion. To elaborate, in some embodiments, starting with the zinc chloride, and further if starting from an ionic liquid composition of [Zn(OH₂)₆][ZnCl₄] an anionic form of zinc is provided in the composition. Thus, in some embodiments, the presently disclosed compositions provide zinc availability with half of the zinc present as a cationic complex and half the zinc present as an anionic complex. By way of additional example for mixed metal systems, and by further example copper/zinc (Cu/Zn) systems, Zn is much more chlorophyllic, thus in the presence of chloride forms the [ZnCl₄]²⁻ anion whereas the Cu is much more likely to persist as the hydrated cation.

Referring particularly to a zinc cellulose embodiment, cellulose is a coordinating ligand directly bound to the zinc. In this form, the binding of zinc to cellulose modulates absorption such that zinc can be delivered to the large intestine (lower gut or lower digestive track) where it provides therapeutic effects. Cellulose binding to the zinc source protects it from premature degradation and absorption into the gastrointestinal tract. Cellulose remains undigested until entry into the ceca (for poultry) or cecum (for swine). However, once into the lower gut, the cellulose can be fermented by bacteria, releasing the zinc. By exploiting this process, the cellulose-zinc nutritional supplement composition allows for the targeted delivery of zinc directly to where it can act as an antimicrobial agent as well as a nutritional supplement.

Cellulose is a complex carbohydrate, which is non-toxic and is utilized as a fiber component in feeds. And zinc chloride is a highly soluble form of zinc that is also approved for both human and animal nutrition. In this composite material the highly bioavailable form of zinc can be delivered to locations farther along the digestive track, particularly the large intestine. While exemplified as a cellulose/zinc chloride complex, the presently disclosed subject matter provides compositions in which any number of polysaccharides can similarly be complexed with zinc chloride, as well as a platform delivery system in which additional dietary metals can also be molecularly incorporated into cellulose or other polysaccharides.

The high bioavailability of a material delivered to the deep gut provides a nutrient delivery system that avoids the necessity of feeding high levels of zinc in the diet, a practice currently done with zinc oxide, the only material to date that effectively delivers zinc to the lower gut. The limited bioavailability of ZnO results in high levels of zinc excretion in manure which, when utilized as fertilizer, results in substantial soil and water contamination.

As disclosed herein above the presently disclosed nutritional supplement compositions can be administered to monogastrics (predominantly swine and poultry) populations for which there is a need to deliver Zn and/or other dietary metals to the lower gut, particularly the ceca (poultry) and cecum (swine). However, the presently disclosed compositions have application as a nutritional supplement for any number of animal populations, including ruminant livestock. The presently disclosed compositions also exhibit value for human nutrition.

Representative, non-limiting studies of the animal health benefits pertain to the intestinal health in swine and poultry. The effectiveness is determined by measuring the amount of Zn delivered to specific places in the digestive tract as well as comparing the digestibility, bioavailability and retention of Zn from a Zn-cellulose embodiment of the presently disclosed nutritional supplement composition. A benefit of this composition is to enhance the Zn delivery to, and absorption into the lower gut while limiting the amount of Zn that is excreted into the environment.

In these studies, fermentation of the cellulose in the gut is also likely to be facilitated by the presence of the ZnCl₂ which, in the presence of mineral acid, is known to catalyze the breakdown of cellulose into simple sugars. The simple sugars can be an additional source of caloric input for the animal. Thus, it is expected that the tested Zn-cellulose embodiment will enhance the growth of the animals, which is measured by enhanced weight gain of the animal, among other options.

Controlled trials with 32 barrows (male swine) are conducted. These studies determine the total tract digestibility of energy and nutrients, including zinc. This data is also at least partially applicable to other monogastric species, including poultry and humans.

A set of trials in poultry, with over 200 poults, is conducted. Data are collected to determine the delivery of a Zn-cellulose embodiment to the ceca of chicks and to determine the microbiota shifts in animals fed the Zn-cellulose embodiment compared to controlled feed. Compositions of the presently disclosed subject matter provide the same or better therapeutic effects, improving the microbial health in the lower gut of swine and poultry as does ZnO when feeding less than 10% the amount of zinc to the animal. The composition of the presently disclosed subject matter is highly bioavailable while also effectively targeting delivery to the lower gut, specifically the ceca in poultry and cecum in swine.

A representative animal trial used a group of 16 barrows (castrated male pigs) including of 8 pairs of littermates. Pigs had an average starting weight of approximately 28 kilograms. The littermate pairs were divided in half and randomly assigned to either the control diet or the test diet containing a composition of the presently disclosed subject matter. Each diet was formulated using a basal diet primarily of corn and soybean meal containing 50 ppm Zn from an added vitamin premix. The control diet contained an additional 50 ppm Zn from Basic Zinc Chloride (Zn₅Cl₂(OH)₈.H₂O) and the test diet contained an additional 50 ppm Zn from a composition of the presently disclosed subject matter for a total of 100 ppm Zn for each diet to meet the National Research Council recommendation for zinc supplementation of pigs of this size. The composition of the presently disclosed subject matter was prepared as described herein above.

Pigs were fed twice daily at 0800 and 1700 for the entirety of the trial. Daily feed intake for maintenance was determined for each pig at 4% of initial body weight at the beginning of the trial. Each pig was housed in a separate metabolism crate allowing for the quantitative collection of feces and urine. The trial lasted for a total of 14 days; the first 10 days allowed for the pigs to adjust to their new environments and diets. Days 11-13 for were used for twice-daily feces and urine collection. On day 14 all pigs were weighed and humanely euthanized prior to dissections to obtain ileal and cecal content samples. Feces samples and urine samples were pooled daily and stored at −20 C until ready for analysis. Fecal, ileal, and cecal samples were dried at 64 C in a drying oven until no change in mass was observed which took between 48-96 hours for most samples. After being dried completely, samples were sent to Missouri Field Laboratories for analysis of Zn, Titanium dioxide which was used as a feed marker, and proximate nutrient analysis. Pigs gained an average of 7.34 kilograms per pig during the 14 day trial. No signs of poor health or nutrient deficiency were observed for either treatment.

Upon analysis, the experimental diets were found to contain higher levels of zinc than formulated. The control diet, containing all supplemental zinc from basic zinc chloride, contained 134 ppm zinc. The experimental diet, formulated to contain 50 ppm of zinc from basic zinc chloride and 50 ppm zinc from a composition of the presently disclosed subject matter, was found to have 152 ppm zinc. This may be indicative of the composition of the presently disclosed subject matter having higher levels of zinc than used in formulation of the diets. Fecal, cecal and ileal samples were analyzed for zinc concentration and the results are shown in Table 1. There was a greater concentration of zinc in all of the samples analyzed from pigs fed the treatment with a composition of the presently disclosed subject matter (referred to in Table 1 as “Experimental”) than the Control treatment.

TABLE 1
Concentration of Zinc (ppm) found in contents
of the ileum, cecum and feces

| | Ileal | Cecal | Fecal |
|---|---|---|---|
| Control | 408 | 399 | 678 |
| Experimental | 512 | 566 | 876 |

Using the concentration of zinc found in the feed and ileal, cecal and fecal samples, zinc digestibility by the following equation: 100−[100*(zinc in feed/zinc in feces)]. The results of digestibility calculations are found in Table 2. Since the amounts of zinc present in the diets were over the zinc requirement of pigs of this size and age, the extra zinc in the diets employing a composition of the presently disclosed subject matter (referred to as “Experimental” in Table 2) may have affected the zinc digestibility results.

TABLE 2
Percent Digestibility of Zinc in Feed

| | Ileal | Cecal | Fecal |
|---|---|---|---|
| Control | 62.6 | 66.1 | 80.2 |
| Experimental | 72.3 | 69.9 | 82.6 |

Comparison of the total zinc in the ileal and cecal samples vs. the fecal zinc to the total amount of zinc demonstrates that the ratio of zinc retained in the ilium and cecum to that excreted in the feces is not different between the control (54.3% ilium+cecum to 45.7% feces) and experimental (55.2% ilium+cecum to 44.8% feces) diets. However, while the control diet exhibits 2.2% more zinc in the ilium than the cecum, the experimental diet results in 10.5% more zinc in the cecum than in the ilium, demonstrating the delivery to the lower gut is higher using a composition of the presently disclosed subject matter as compared to a dietary metal without cellulose as a coordinating ligand.

All references cited in the instant disclosure, including but not limited to all patents, patent applications, and publications thereof, scientific journal articles, and database entries are incorporated herein by reference in their entireties to the extent that they supplement, explain, provide a background for, or teach methodology, techniques, and/or compositions employed herein.

Many modifications and other embodiments of the presently disclosed subject matter will come to mind to one skilled in the art to which this presently disclosed subject matter pertains having the benefit of the teachings presented in the foregoing description. Therefore, it is to be understood that the presently disclosed subject matter is not to be limited to the specific embodiments disclosed and that modifications and other embodiments are intended to be included within the scope of the appended claims. Although specific terms are employed herein, they are used in a generic and descriptive sense only and not for purposes of limitation.

It will be understood that various details of the presently disclosed subject matter can be changed without departing from the scope of the presently disclosed subject matter. Furthermore, the foregoing description is for the purpose of illustration only, and not for the purpose of limitation.

What is claimed is:

1. A method of delivering a dietary metal to a subject in need thereof, the method comprising:
providing a composition comprising an effective amount of a dietary metal and a coordinating ligand, wherein the coordinating ligand encapsulates the dietary metal and/or the dietary metal is provided as a cationic complex and/or as an anionic complex and wherein the coordinating ligand coordinates the dietary metal cationic complex and/or the dietary metal anionic complex; and
administering the composition to the subject, optionally perorally.

2. The method of claim 1, wherein the dietary metal is selected from the group comprising zinc (Zn), copper (Cu), magnesium (Mg), manganese (Mn), iron (Fe), cobalt (Co), and combinations thereof.

3. The method of claim 1 or claim 2, wherein the coordinating ligand comprises a water insoluble polysaccharide (PS).

4. The method of any of the preceding claims, wherein the coordinating ligand comprises cellulose.

5. The method of any of the preceding claims, wherein the dietary metal anionic complex comprises a dietary metal halide complex and/or wherein the dietary metal cationic complex comprises a dietary metal hydrate complex.

6. The method of any of the preceding claims, wherein the dietary metal anionic complex comprises a [ZnCl₄]²⁻ complex and/or a [ZnCl_{4-y}(OH)_{y}]²⁻ complex, and/or wherein the dietary metal cationic complex comprises a [Zn(OH₂)₆]²⁺ complex or a [Zn(OH₂)₆₋ₙ(PS)ₙ]²⁺ complex.

7. The method of claim 6, wherein Zn is present in an amount ranging up to about 50 wt. %, optionally up to about 30 wt. %.

8. The method of any one of claims 6-7, wherein PS is cellulose.

9. The method of any of the preceding claims, wherein the composition comprises [M(OH₂)ₓ(PS)][ZnCl₄], wherein M is a dietary metal or a combination of dietary metals, wherein PS is a polysaccharide, and wherein x ranges from 0 to 18, optionally 0 to 6.

10. The method of claim 9, wherein M is selected from the group consisting of Zn, Cu, Mg, Mn, Fe, Co, and combinations thereof.

11. The method of claim 8, wherein M is selected from the group consisting of Zn, Cu, and combinations thereof.

12. The method of any one of claims 9-11, wherein M is present in an amount ranging up to about half of the total metal content, optionally up to about 15 wt. %.

13. The method of any one of claims 9-12, wherein PS is cellulose.

14. The method of any of the preceding claims, wherein the dietary metal anionic complex comprises about half the dietary metal in the composition and wherein the dietary metal cationic complex comprises about half the dietary metal in the composition.

15. The method of any of the preceding claims, wherein the composition is prepared by dissolving the coordinating ligand in an ionic liquid composition comprising the dietary metal anionic complex and the dietary metal cationic complex, optionally further comprising precipitating the composition.

16. The method of any of the preceding claims, wherein the composition further comprises a biologically acceptable excipient and/or carrier, in addition to the coordinating ligand.

17. The method of any of the preceding claims, wherein the subject is a non-human animal subject, optionally a monogastric subject, further optionally a swine subject or a poultry subject, or is a human subject.

18. The method of any of the preceding claims, wherein administering the composition delivers the dietary metal to a lower gut of the subject, optionally wherein the delivery to the lower gut is higher as compared to a dietary metal without a coordinating ligand.

19. The method of any of the preceding claims, wherein the digestibility of the composition in the upper gut of the subject is substantially reduced as compared to a composition without a coordinating ligand.

20. A nutritional supplement composition for peroral administration, comprising an effective amount of a dietary metal and a coordinating ligand, wherein the coordinating ligand encapsulates the dietary metal and/or the dietary metal is provided as a cationic complex and/or as an anionic complex and wherein the coordinating ligand coordinates the dietary metal cationic complex and/or the dietary metal anionic complex.

21. The nutritional supplement composition of claim 20, wherein the dietary metal is selected from the group comprising zinc (Zn), copper (Cu), magnesium (Mg), manganese (Mn), iron (Fe), cobalt (Co) and combinations thereof.

22. The nutritional supplement composition of claim 20 or claim 21, wherein the coordinating ligand comprises a water insoluble polysaccharide (PS).

23. The nutritional supplement composition of any of one of claims 20-22, wherein the coordinating ligand comprises cellulose.

24. The nutritional supplement composition of any of one of claims 20-23, wherein the dietary metal anionic complex comprises a dietary metal halide complex and wherein the dietary metal cationic complex comprises a dietary metal hydrate complex.

25. The nutritional supplement composition of any of one of claims 20-24, wherein the dietary metal anionic complex comprises a [ZnCl₄]²⁻ complex/or a [ZnCl_{4-y}(OH)_{y}]²⁻ complex, and/or wherein the dietary metal cationic complex comprises a [Zn(OH₂)₆]²⁺ complex or a [Zn(OH₂)₆₋ₙ(PS)ₙ]²⁺ complex.

26. The nutritional supplement composition of claim 25, wherein Zn is present in an amount ranging up to about 50 wt. %, optionally up to about 30 wt. %.

27. The nutritional supplement composition of any one of claims 25-26, wherein PS is cellulose.

28. The nutritional supplement composition of any of one of claims 20-27, wherein the composition comprises [M(OH₂)ₓ(PS)][ZnCl₄], wherein M is a dietary metal or a combination of dietary metals, wherein PS is a polysaccharide, and wherein x ranges from 0 to 18, optionally 0 to 6.

29. The nutritional supplement composition of claim 28, wherein M is selected from the group consisting of Zn, Cu, Mg, Mn, Fe, Co, and combinations thereof.

30. The nutritional supplement composition of claim 29, wherein M is selected from the group consisting of Zn, Cu, and combinations thereof.

31. The nutritional supplement composition of any one of claims 28-30, wherein M is present in an amount ranging up to about half of the total metal content, optionally up to about 15 wt. %.

32. The nutritional supplement composition of any of one of claims 28-31, wherein PS is cellulose.

33. The nutritional supplement composition of any one of claims 20-32, wherein the composition comprises a morphology selected from the group consisting of a power, a gel, and a film.

34. The nutritional supplement composition of any one of claims 20-33, wherein the dietary metal anionic complex comprises about half the dietary metal in the composition and wherein the dietary metal cationic complex comprises about half the dietary metal in the composition.

35. The nutritional supplement composition of any one of claims 20-34, wherein the composition is prepared by dissolving the coordinating ligand in an ionic liquid composition comprising the dietary metal anionic complex and the dietary metal cationic complex, optionally further comprising precipitating the composition.

36. The nutritional supplement composition of any of one of claim 20-35, wherein the composition further comprises a biologically acceptable excipient and/or carrier, in addition to the coordinating ligand.

37. The nutritional supplement composition of any of one of claims 20-36, wherein the nutritional supplement composition is adapted for administration to a non-human animal subject, optionally a monogastric subject, further optionally a swine subject or a poultry subject, or to a human subject.

38. The nutritional supplement composition of any of one of claims 20-37, wherein the composition delivers the dietary metal to a lower gut of the subject, optionally wherein the delivery to the lower gut is higher as compared to a dietary metal without a coordinating ligand.

39. The nutritional supplement composition of any one of claims 20-38, wherein the digestibility of the composition in the upper gut of the subject is substantially reduced as compared to a composition without a coordinating ligand.

40. A composition, comprising a dietary metal and a coordinating ligand, wherein the coordinating ligand encapsulates the dietary metal and/or wherein the dietary metal is provided as a cationic complex and/or as an anionic complex and wherein the coordinating ligand coordinates the dietary metal cationic complex and/or the dietary metal anionic complex.

41. The composition of claim 40, wherein the dietary metal is selected from the group comprising zinc (Zn), copper (Cu), magnesium (Mg), manganese (Mn), iron (Fe), cobalt (Co) and combinations thereof.

42. The composition of claim 40 or claim 41, wherein the coordinating ligand comprises a water insoluble polysaccharide (PS).

43. The composition of any one of claims 40-42, wherein the coordinating ligand comprises cellulose.

44. The composition of any one of claims 40-43, wherein the dietary metal anionic complex comprises a dietary metal halide complex and wherein the dietary metal cationic complex comprises a dietary metal hydrate complex.

45. The composition of any one of claims 40-44, wherein the dietary metal anionic complex comprises a [ZnCl₄]²⁻ complex/or a [ZnCl_{4-y}(OH)_{y}]²⁻ complex, and/or wherein the dietary metal cationic complex comprises a [Zn(OH₂)₆]²⁺ complex or a [Zn(OH₂)₆₋ₙ(PS)ₙ]²⁺ complex.

46. The composition of claim 45, wherein Zn is present in an amount ranging up to about 50 wt. %, optionally up to about 30 wt. %.

47. The composition of any one of claims 6-7, wherein PS is cellulose.

48. The composition of any one of claims 40-47, wherein the composition comprises [M(OH₂)ₓ(PS)][ZnCl₄], wherein M is a dietary metal or a combination of dietary metals, wherein PS is a polysaccharide, and wherein x ranges from 0 to 18, optionally 0 to 6.

49. The composition of claim 48, wherein M is selected from the group consisting of Zn, Cu, Mg, Mn, Fe, Co, and combinations thereof.

50. The composition of claim 49, wherein M is selected from the group consisting of Zn, Cu, and combinations thereof.

51. The composition of any one of claims 48-50, wherein M is present in an amount ranging up to about half the total metal content, optionally up to about 15% by weight.

52. The composition of any one of claims 48-51, wherein PS is cellulose.

53. The composition of any one of claims 40-52, wherein the dietary metal anionic complex comprises about half the dietary metal in the composition and wherein the dietary metal cationic complex comprises about half the dietary metal in the composition.

54. The composition of any one of claims 40-53, wherein the composition is prepared by dissolving the coordinating ligand in an ionic liquid composition comprising the dietary metal anionic complex and the dietary metal cationic complex, optionally further comprising precipitating the composition.

55. The composition of any one of claims 40-54, wherein the composition comprises a morphology selected from the group consisting of a power, a gel, and a film.

56. An ionic liquid composition comprising the formula [Zn(OH₂)₆(OH₂)ₓ][ZnCl_{4-y}(OH)_{y}], wherein x ranges for 4 to 36.
